(19) United States
(12) Patent Application Publication
(10) Pub. No.: US 2016/0148595 A1
(43) Pub. Date: May 26, 2016

(54) Electronic Display

(71) Applicants: Gennarino Capasso, Rome (IT); SIMONA CAPASSO, HERZELYA (IL); NATALIE CAPASSO, HERZELYA (IL)

(72) Inventors: Gennarino Capasso, Rome (IT); SIMONA CAPASSO, HERZELYA (IL); NATALIE CAPASSO, HERZELYA (IL)

(21) Appl. No.: 14/952,940

(22) Filed: Nov. 26, 2015

Related U.S. Application Data
(60) Provisional application No. 62/084,774, filed on Nov. 26, 2014.

(51) Int. Cl. G09G 5/00

(52) U.S. Cl. CPC G09G 5/006; G09G 2370/16

(57) ABSTRACT

Disclosed are electronic product displays which include at least one indicator configured for placement along a product display; and, a transceiver, electronically coupled with the at least one indicator. The transceiver controls the indicia presented by the at least one indicator, and receives signals from a controller for controlling the indicia presented by the at least one indicator.

### CROSS-REFERENCE TO RELATED APPLICATIONS

This application is related to and claims priority from commonly owned U.S. Provisional Patent Application Ser. No. 62/084,774, entitled: Electronic Display, filed on Nov. 26, 2014, the disclosure of which is incorporated by reference in its entirety herein.

### TECHNICAL FIELD

The present invention is directed to product displays.

### BACKGROUND

Product displays are used at the point of sale. These product displays are typically mechanical structures, which hold the product, so that consumers can take the product from the product display for purchase.

### SUMMARY

The present invention is directed to product displays which are electronic. Embodiments of the invention are directed to a product display comprising: at least one indicator configured for placement along a product display; and, a transceiver in electronic communication with the at least one indicator, the transceiver configured for: a) controlling the indicia presented by the at least one indicator; and, b) receiving signals from a controller for controlling the indicia presented by the at least one indicator. The transceiver is optionally configured for receiving radio-frequency signals.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of a system of the apparatus of the invention at a first time;

FIG. 2 is a diagram of a system of the apparatus of the invention at a second time, later than the first time;

FIG. 3A is a front view of a display device attachable to an article of clothing; and,

FIG. 3B is a cross sectional side view of the display device of FIG. 3A taken along line 3B-3B.

### DETAILED DESCRIPTION OF THE DRAWINGS

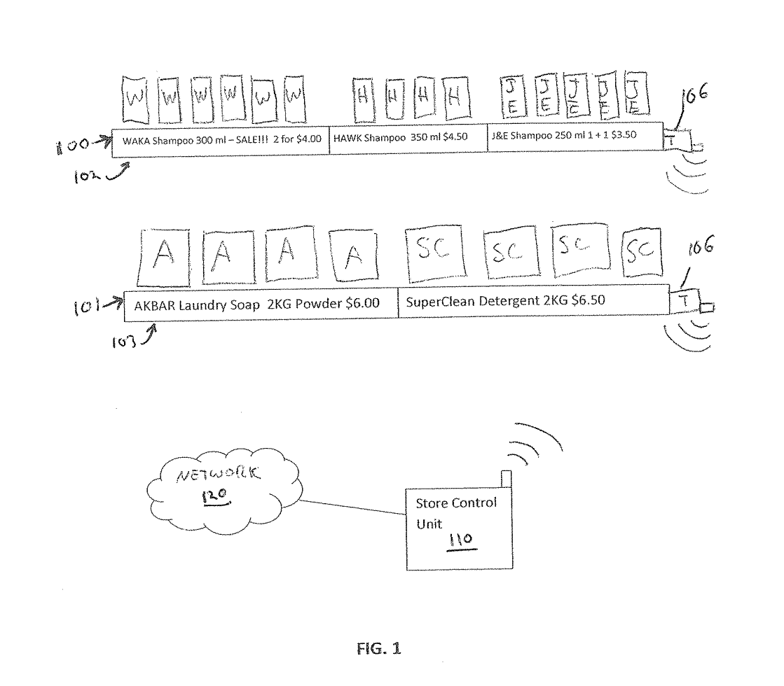

FIG. 1A shows displays 100, 101 along shelves 102, 103, where products are displayed. The displays 100, 101 are, for example, Light Emitting Diode (LED) based, and connects to transceivers (T) 106, which are linked, via both electronic and data, and wireless or wired to a store control unit 110.

This store control unit 110 is, for example, a computer, using communication methods such as Bluetooth®, Radio Frequency (RF), wifi®, GSM, and other technologies, for communicating with the transceivers (T) 106, associated with the respective displays 100, 101.

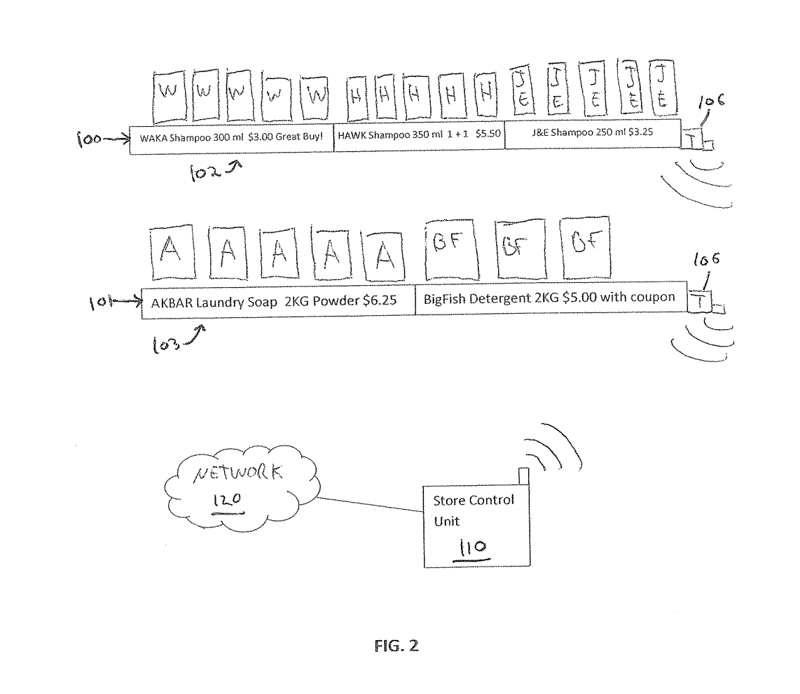

A user can change the displays 100, 101 through the store control unit 110, for example, as shown in FIG. 2, which are the displays 100, 101 at a second time, later than the first time. For example, at a first time, WAKA Shampoo is on sale at “2 for $4.00.” At time 2 in FIG. 2, which is for example, a week later, WAKA Shampoo is no longer on sale but priced at $3.00 per bottle. Also, in the lower shelf display, SuperClean Detergent has been replaced by BigFish Detergent.

Should the manufacturer or other entity associated with a product or products on a display 100, 101, the display can be controlled over the network 120, such as the Internet, to which the store controller 110 is linked. The data from over the internet is sent to the store controller 110, which then send the information to the transceiver (T) 106 associated with the display 100, 101, so that the display 100, 101 can be changed accordingly.

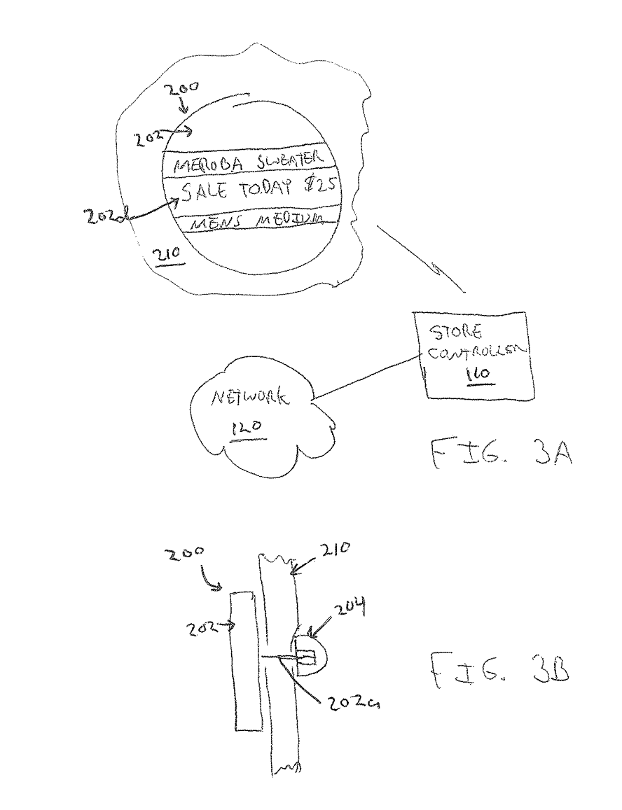

FIGS. 3 A and 3B detail a tag, such as an anti-theft tag 200 (usable with an anti-theft system) which is removable by the seller, once the item, to which the tag was attached, is purchased and permitted to leave the retailer's premises.

The tag 200 includes a main member 202 with a pin 202a, received in a cap 204. The pin 202 extends through a clothing item 210. The tag 200, at the main member 202 includes a transceiver (not shown) which is linked to the store control unit, which is linked to a network, such as the Internet, similar to that shown in FIGS. 1 and 2, as detailed above. The main member 200 includes a display 202d, changeable via the store control unit, as detailed above for FIGS. 1 and 2.

The display 202d is also able to present and transmit messages to customers, such as those registered in the store's network. These messages may be personal, such as “hello”, or business, e.g., “Special Offer for You as a Member of Our Club,” or mixed, “Welcome, Please visit our sweater section for more special values in your favorite colors.”

The display 202d, while shown with clothes, is not limited thereto.

Through the network 120, both the displays 100, 101 and 200d, the store controllers 110 can link to social networks, such as facebook®, GoogleGroups™, and the like.

The systems of FIGS. 1, 2, 3A and 3B are operable with programs connectable with the seller's (store's) network and to receive on-line data. The displays 100, 101, 202d may list information such as item prices, special sales, advertisement messages and commercial information received from the seller's or over the Internet.

The systems of FIGS. 1, 2, 3A and 3B are constructed to operate with programs for that particular store or local area of the store, and can also recorded customer comments and messages about the products being displayed.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A product display comprising:
at least one indicator configured for placement along a product display; and,
a transceiver in electronic communication with the at least one indicator, the transceiver configured for: a) controlling the indicia presented by the at least one indicator; and, b) receiving signals from a controller for controlling the indicia presented by the at least one indicator.

2. The product display of claim 1, wherein the transceiver is configured for receiving radio-frequency signals.
